(19) United States
(12) Patent Application Publication
(10) Pub. No.: US 2018/0335197 A1
(43) Pub. Date: Nov. 22, 2018

(54) AIR-BAG-FORM LAMPSHADE

(71) Applicant: AIECOS CO., INC., Hsinchu City (TW)

(72) Inventors: Shih-Yun CHEN, Hsinchu City (TW); Fu-Hsing HOU, Hsinchu City (TW)

(21) Appl. No.: 15/984,399

(22) Filed: May 20, 2018

(30) Foreign Application Priority Data
May 19, 2017 (TW) 106207176

(51) Int. Cl. F21V 1/14; F21V 17/00

(52) U.S. Cl. CPC F21V 1/146; F21V 17/007

(57) ABSTRACT

An air-bag-form lampshade for receiving a light emitting element is provided. The air-bag-form lampshade includes an expandable and foldable lampshade body, a flat plate and a hollow inner layer. The lampshade body has an opening. The flat plate is attached to a portion of an inner surface or an outer surface of the lampshade body. The portion of the lampshade body forms a lampshade standing plane. The hollow inner layer is disposed corresponding to the opening and connected to the lampshade body. The hollow inner layer is disposed inside the lampshade body and includes an accommodating space. The accommodating space receives the light emitting element. The air-bag-form lampshade can be carried and stored easily, and it can be assembled to other carrier having the light emitting element.

### TECHNICAL FIELD

The present invention relates to a lampshade and, in particular, to an air-bag-form lampshade.

### BACKGROUND

Lampshades are used to cover a light emitting element to diffuse light it emits. In modern society, lampshades are also one of the major means to provide a relaxing or romantic atmosphere.

However, conventional lampshades are usually too big to be carried or stored easily. Consequently, users are unable to carry them around and need to buy new lampshades in different places, which is a waste of money. Furthermore, the lampshades are often fixed to lamps, so it is troublesome and difficult to detach the lampshade. As a result, it is difficult to apply the conventional lampshades to other light emitting elements.

In view of this, the inventor studied various technologies and created an effective solution in the present disclosure.

### SUMMARY

It is an objective to provide an air-bag-form lampshade. The air-bag-form lampshade is expandable and foldable and can cover any carrier having a light emitting element to receive it inside an accommodating space of the lampshade. It is easy and convenient to carry and store the lampshade. Moreover, the lampshade can be assembled to other carrier to diffuse light emitted from its light emitting element.

Accordingly, the present invention provides an air-bag-form lampshade for receiving a light emitting element. The air-bag-form lampshade includes a lampshade body, a flat plate and a hollow inner layer. The lampshade body is expandable and foldable and has an opening. The flat plate is attached to a portion of an inner surface of the lampshade body or to a portion of an outer surface of the lampshade body. The portion of the lampshade body forms a lampshade standing plane. The hollow inner layer is disposed corresponding to the opening and connected to the lampshade body. The hollow inner layer is disposed inside the lampshade body and includes an accommodating space. The accommodating space receives the light emitting element.

Compared to conventional techniques, the present invention has the following advantages. It is easy to carry and store the lampshade. The lampshade can be assembled to other carrier to diffuse light emitted from its light emitting element.

### BRIEF DESCRIPTION OF THE DRAWINGS

The disclosure will become more fully understood from the detailed description and the drawings given herein below is for illustration only, and thus does not limit the disclosure, wherein:

FIG. 1 is a perspective view illustrating a lampshade according to the first embodiment of the present invention;

FIG. 2 is a bottom view illustrating the lampshade according to the first embodiment of the present invention;

FIG. 3 is a cross-sectional view illustrating the lampshade according to the first embodiment of the present invention;

FIG. 4 is a perspective view illustrating that the lampshade covers the first kind of carrier having a light emitting element according to the first embodiment of the present invention;

FIG. 5 is a cross-sectional view of FIG. 4 illustrating the lampshade;

FIG. 6 is a cross-sectional view illustrating that the lampshade covers the second kind of carrier having the light emitting element according to the first embodiment of the present invention;

FIG. 7 is a cross-sectional view illustrating the lampshade according to the second embodiment of the present invention;

FIG. 8 is a cross-sectional view illustrating the lampshade according to the third embodiment of the present invention;

FIG. 9 is a cross-sectional view illustrating the lampshade according to the fourth embodiment of the present invention;

FIG. 10 is a cross-sectional view illustrating the lampshade according to the fifth embodiment of the present invention; and

FIG. 11 is a cross-sectional view illustrating the lampshade according to the sixth embodiment of the present invention.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

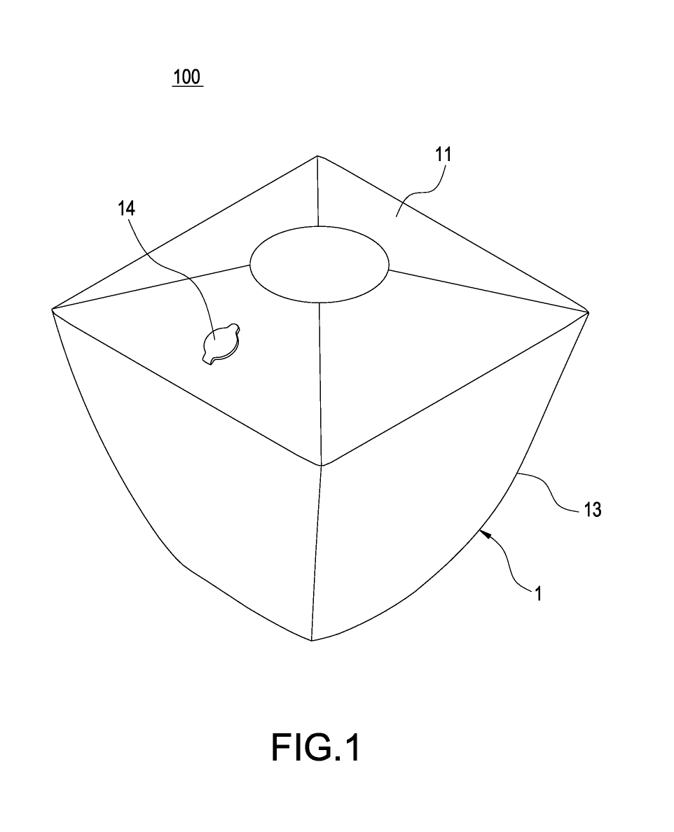

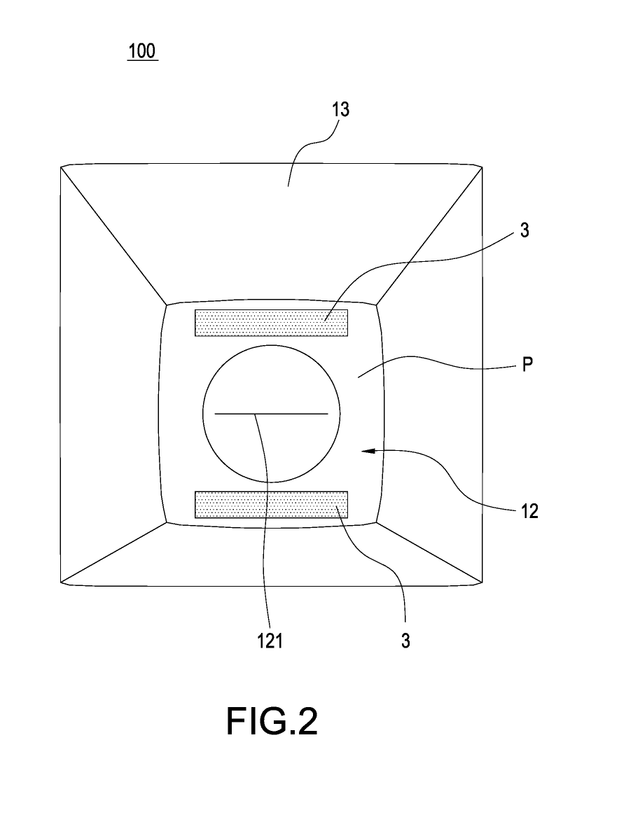

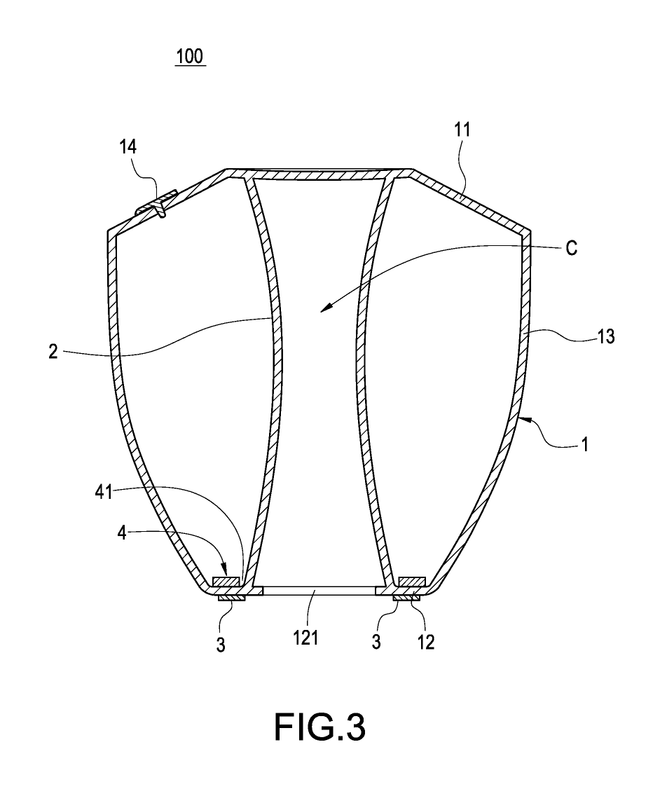

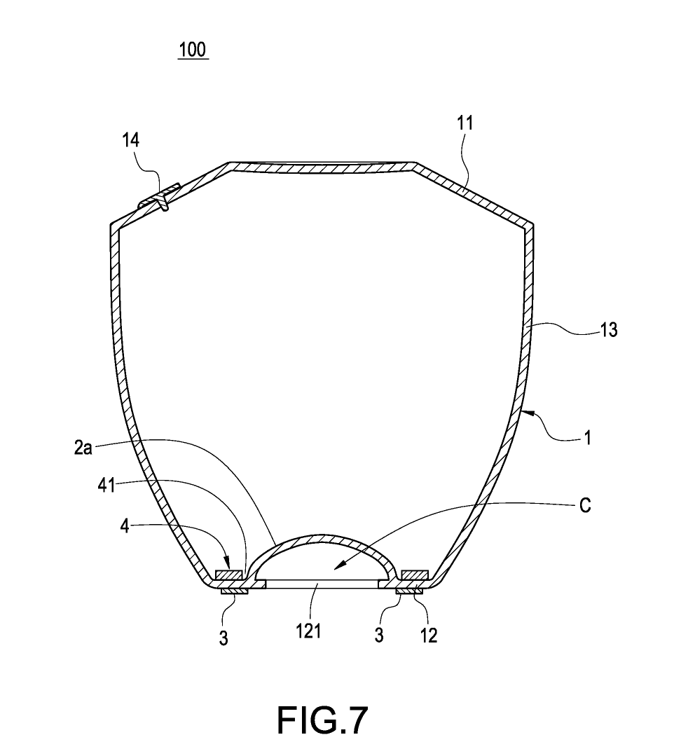

The present invention provides an air-bag-form lampshade. FIGS. 1 to 6 illustrate the first embodiment. FIGS. 7 to 11 illustrate the second to six embodiments.

Referring to FIGS. 1 to 3, the lampshade 100 is used to receive a light emitting element 800. The lampshade 100 includes a lampshade body 1, a flat plate 4 and a hollow inner layer 2. The lampshade body 1 is expandable and foldable and preferably includes at least one connection element 3 (the present embodiment includes multiple connection elements 3 as an example).

The lampshade body 1 can be a one-piece lampshade. The lampshade body 1 includes an upper covering plate 11, a lower covering plate 12 and a surrounding plate 13. The surrounding plate 13 is connected to a periphery of the upper covering plate 11 and a periphery of the lower covering plate 12 to form a closed air bag. The lower covering plate 12 includes a first opening 121 (the first opening 121 can be a slit shown in the drawing or other type of opening).

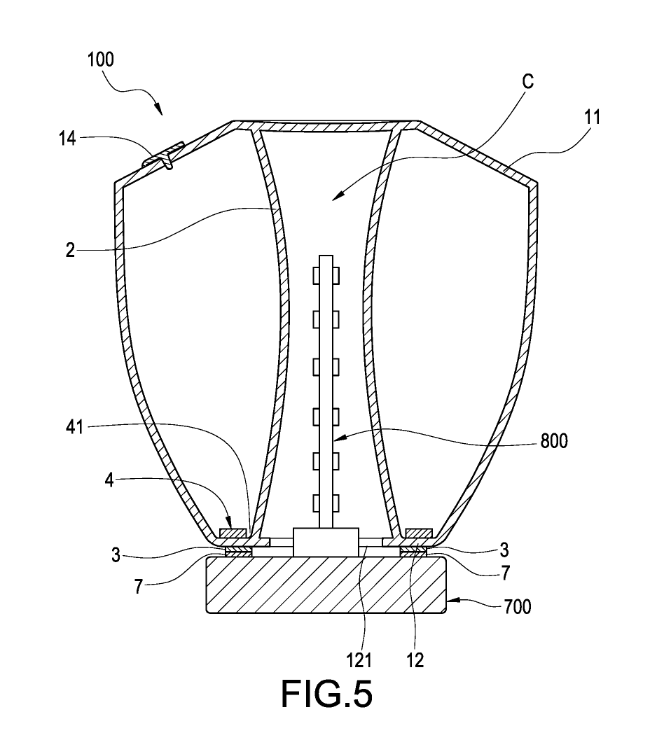

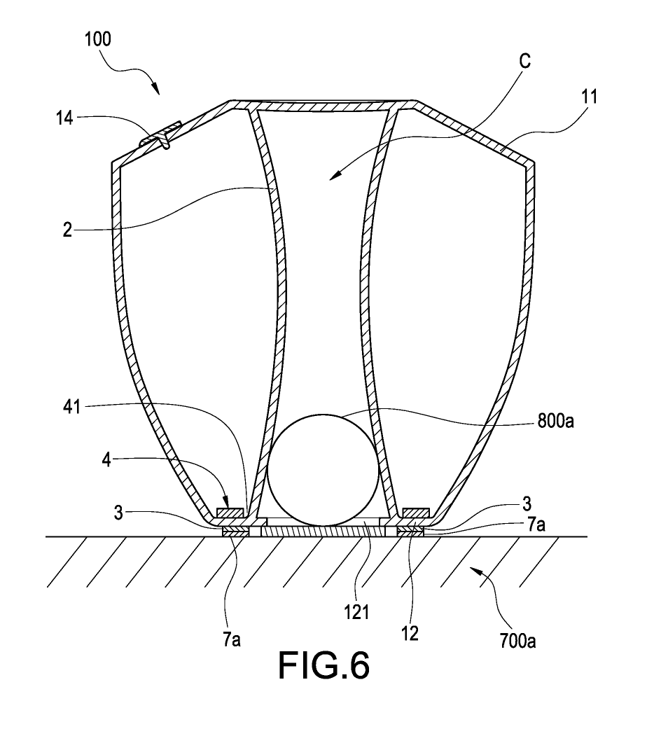

The flat plate 4 is attached to a portion of an inner surface of the lampshade body 1. To be specific, the flat plate 4 is attached to an inner surface of the lower covering plate 12. Therefore, an outer surface of the lower covering plate 12 forms a lampshade standing plane P, so that the lampshade 100 can stably rest on a carrier 700 or a carrier 700a (see FIG. 5 or FIG. 6). The flat plate 4 includes a through hole 41. The hollow inner layer 2 is inserted in the through hole 41. In alternative embodiments not illustrated, the flat plate 4 is attached to a portion of an outer surface of the lampshade body 1. For example, the flat plate 4 can be attached to a portion of an outer surface of the lower covering plate 12, so that the lampshade 100 can stand firmly on the carrier 700 or the carrier 700a by means of the flat plate 4.

The hollow inner layer 2 can be disposed corresponding to the first opening 121 and connected to the lampshade body 1. The hollow inner layer 2 is disposed inside the lampshade body 1. Preferably, the hollow inner layer 2 is connected between an inner surface of the upper covering plate 11 and the inner surface of the lower covering plate 12. The hollow inner layer 2 can be a hollow pillar and provides an accommodating space C. Two ends of the hollow pillar are connected to the upper covering plate 11 and the lower covering plate 12, respectively. The lampshade body 1 and the hollow inner layer 2 can consist of the same material.

An air nozzle 14 is connected to the lampshade body 1, so as to inflate the lampshade body 1 with air or deflate the lampshade body 1 to collapse it.

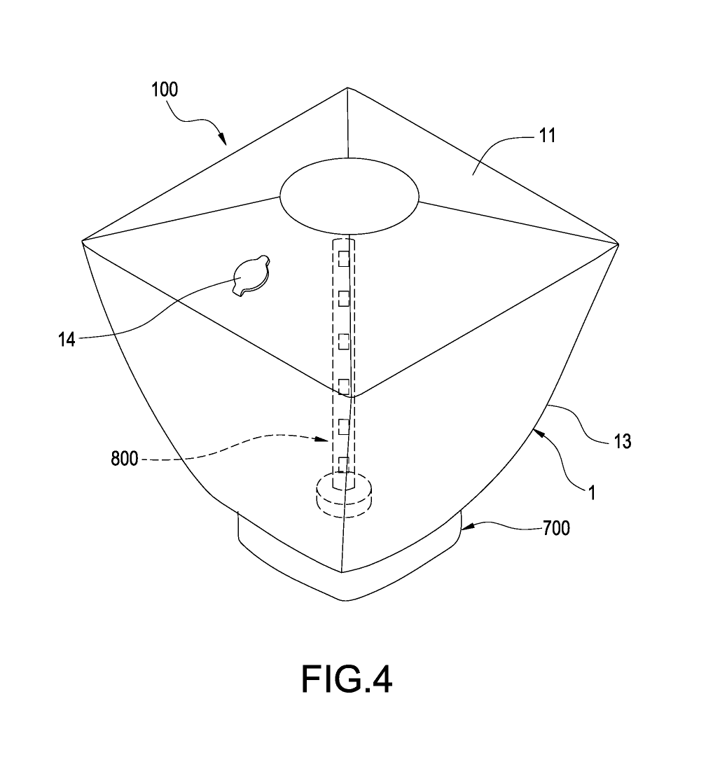

As shown in FIGS. 4 to 6, the light emitting element 800 or a light emitting element 800a is received in the accommodating space C of the hollow inner layer 2 through the first opening 121, so that the light emitting element 800 or the light emitting element 800a can emit light through the lampshade 100.

The lampshade 100 covers the carrier 700 or the carrier 700a. The carrier 700 is disposed with the light emitting element 800, and the carrier 700a is disposed with the light emitting element 800a. In FIG. 5, the lampshade 100 covers the first kind of carrier 700. In FIG. 6, the lampshade 100 covers the second kind of carrier 700a.

In order to fix the lampshade 100 on the carrier 700 or 700a, the connection element 3 is preferably disposed on the outer surface of the lower covering plate 12 of the lampshade body 1, and a corresponding connection element 7a is disposed on the carrier 700 or the carrier 700a, so that the lampshade 100 can be joined to the carrier 700 or the carrier 700a by means of the connection element 3.

As shown in FIGS. 4 and 5, the lampshade 100 is coupled to the first kind of carrier 700, so that the connection element 3 of the lampshade 100 is detachably joined to the corresponding connection element 7, so that the lampshade 100 stands firmly on the carrier 700 by means of the lampshade standing plane P. Meanwhile, the lampshade 100 covers the light emitting element 800 and receives it inside the accommodating space C, so that the light emitting element 800 emits light through the lampshade 100. The first kind of carrier 700 in the present embodiment is a support base as an example. The lampshade 100 is combined with the carrier 700 and the light emitting element 800 to form a lantern (not illustrated) after including a handle on the upper covering plate 11 of the lampshade body 1 for carrying.

The inner surface of the hollow inner layer 2 and the inner surface of the lampshade body 1 are each disposed with a light guiding structure (not illustrated) for guiding the light to provide an even distribution of light. The light guiding structure can consist of a plurality of light guiding particles formed on the respective inner surface to thereby form a matte surface. Alternatively, the light guiding structure can consist of a plurality of light guiding patterns on the respective inner surface; however, the present invention is not limited in this regard.

As shown in FIG. 6, the lampshade body 1 of the lampshade 100 can be combined with the other carrier 700a (i.e. the second kind of carrier 700a shown in the drawing) in such a manner that the connection element 3 is detachably combined with the corresponding connection element 7a to cover the light emitting element 800a, so that the light emitting element 800a in the accommodating space C can emit light through the lampshade 100. The second kind of carrier 700a in this embodiment can be, for example, a flat platform, a table, or a tea table.

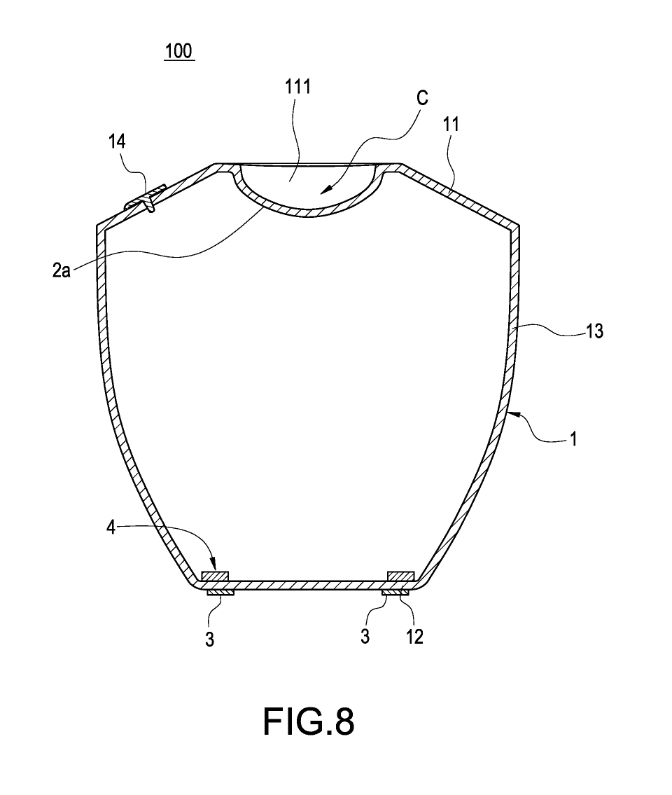

Please refer to FIGS. 7 and 8 for the air-bag-form lampshade according to the second and third embodiments. The second and third embodiments are similar to the first embodiment, and the difference is that the hollow inner layer 2a in the second and third embodiments is a cover. In the second embodiment, the cover is disposed corresponding to the first opening 121 only to cover the same and connected to the inner surface of the lower covering plate 12 of the lampshade body 1. In the third embodiment, the upper covering plate 11 includes a second opening 111. The cover is disposed corresponding to the second opening 111 only to cover the same and connected to the inner surface of the upper covering plate 11 of the lampshade body 1.

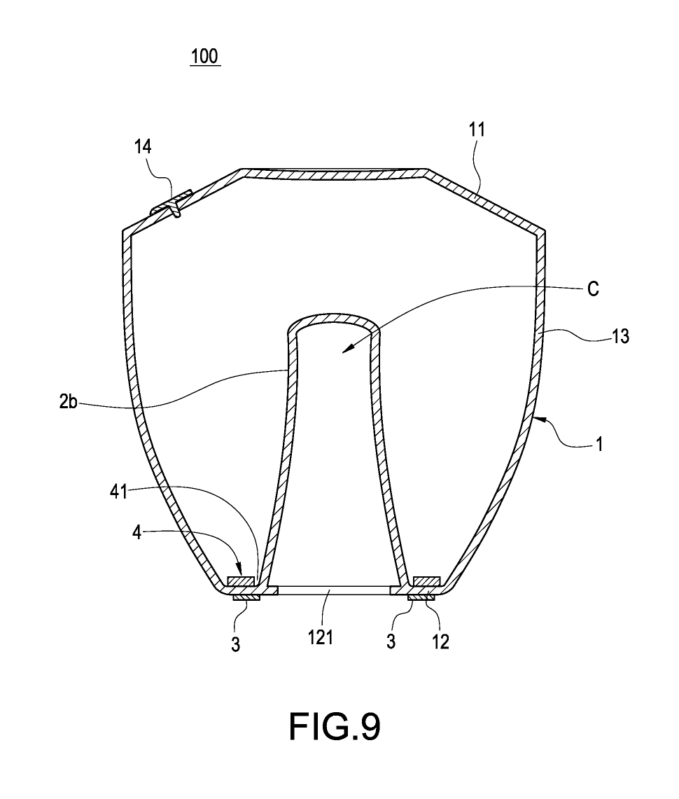

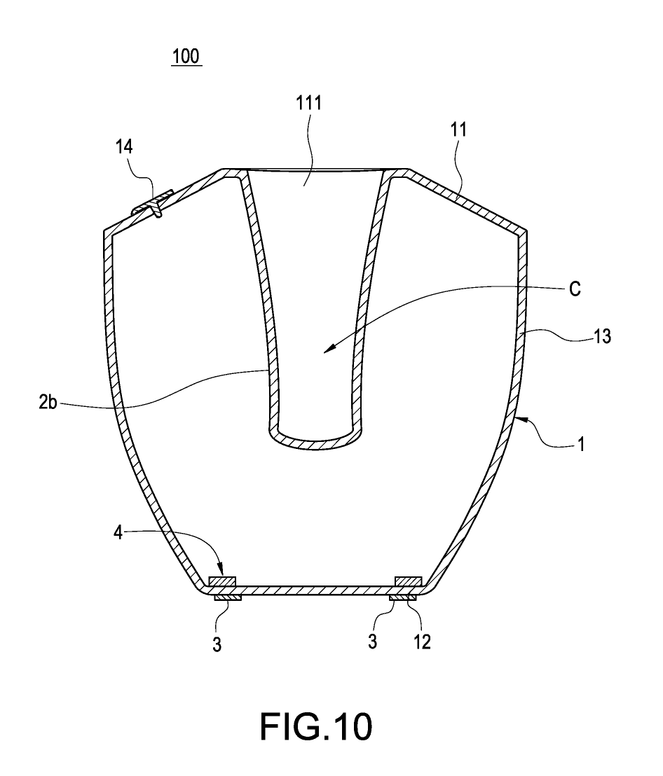

Please refer to FIGS. 9 and 10 for the air-bag-form lampshade according to the fourth and fifth embodiments. The fourth and fifth embodiments are similar to the first embodiment and the difference is that the hollow inner layer 2b of the fourth and fifth embodiments are a hollow pillar with one connected end. In the fourth embodiment, one end of the hollow pillar is disposed corresponding to the first opening 121 only and connected to the inner surface of the lower covering plate 12 of the lampshade body 1. The other end of the hollow pillar is a closed free end. In the fifth embodiment, the upper covering plate 11 includes the second opening 111. One end of the hollow pillar is disposed corresponding to the second opening 111 only and connected to the inner surface of the upper covering plate 11 of the lampshade body 1. The other end of the hollow pillar is a closed free end.

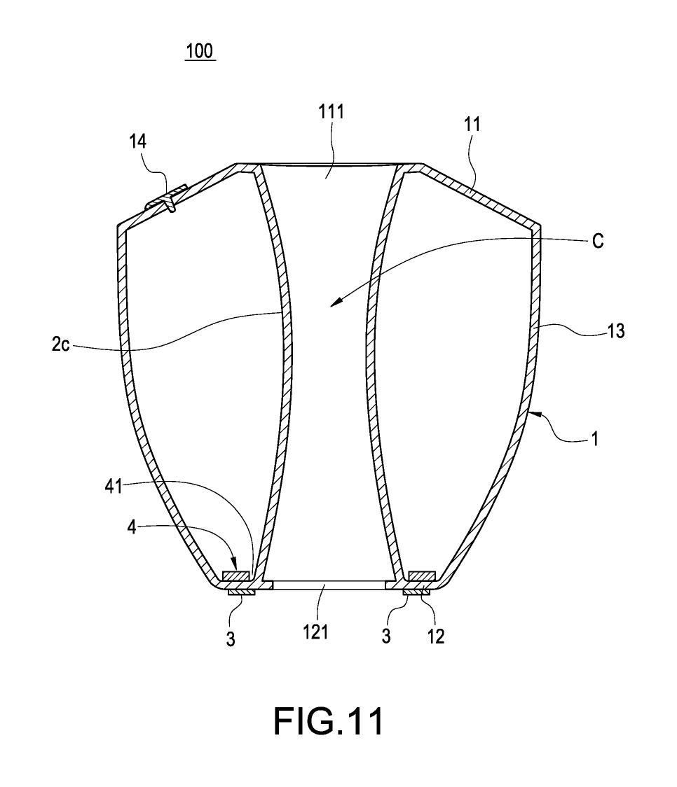

Please refer to FIG. 11 for the air-bag-form lampshade according to the sixth embodiment of the present invention. The sixth embodiment is similar to the first embodiment, and the difference between them is that the upper covering plate 11 of the lampshade body 1 further includes a second opening 111. The hollow inner layer 2c are also a hollow pillar connected at both ends. The two ends of the hollow pillars are disposed corresponding to the first opening 121 and the second opening 111, and are connected to the respective inner surfaces of the upper and lower covering plates 11, 12.

In summary, compared with conventional techniques, the present invention has the following advantages. The lampshade body 1 is expandable to cover any carrier 700 to receive its light emitting element 800 inside the accommodating space C. The lampshade body 1 is foldable for carrying and easy storage and can be assembled to other carrier 700a instead to light up by using the light emitting element 800a thereof.

The present invention also has the following effects. By attaching the flat plate 4 to any portion (e.g. on the lower covering plate 12) of an inner surface or an outer surface of the lampshade body 1, this portion of the lampshade body 1 forms the lampshade standing plane P. By this way, the lampshade 100 stably rests on the carrier 700 or the carrier 700a, i.e. firmly standing on the carrier 700 or the carrier 700a. The whole lampshade 100 provides an even distribution of light by using the light guiding structures on the respective inner surfaces of the hollow inner layer 2 and the lampshade body 1. By putting the light emitting element 800 or the light emitting element 800a inside the hollow inner layer 2, 2a, 2b or 2c with different lengths and shapes, the lampshade 100 can provide different lighting effects.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. An air-bag-form lampshade, for receiving a light emitting element, comprising:
a lampshade body, the lampshade body being expandable and foldable and having an opening;
a flat plate attached to a portion of an inner surface of the lampshade body or to a portion of an outer surface of the lampshade body, the portion of the lampshade body forming a lampshade standing plane; and
a hollow inner layer disposed corresponding to the opening and connected to the lampshade body, the hollow inner layer being disposed inside the lampshade body and including an accommodating space, the accommodating space receiving the light emitting element.

2. The air-bag-form lampshade according to claim 1, wherein the hollow inner layer is a cover.

3. The air-bag-form lampshade according to claim 1, wherein the hollow inner layer is a hollow pillar, one end of the hollow pillar is disposed corresponding to the opening and connected to the lampshade body, and the other end of the hollow pillar is a closed free end.

4. The air-bag-form lampshade according to claim 1, wherein the hollow inner layer is a hollow pillar, one end of the hollow pillar is disposed corresponding to the opening and connected to the portion of the inner surface of the lampshade body, the other end of the hollow pillar is connected to another portion of the inner surface of the lampshade body, and the portion of the inner surface and the another portion of the inner surface are disposed opposite to each other.

5. The air-bag-form lampshade according to claim 4, wherein the lampshade body includes another opening, and the other end of the hollow pillar is disposed to the another opening and connected to the another portion of the inner surface.

6. The air-bag-form lampshade according to claim 1, further comprising an air nozzle, the air nozzle being connected and communicating with the lampshade body.

7. The air-bag-form lampshade according to claim 1, wherein the opening of the lampshade body is a slit.

8. The air-bag-form lampshade according to claim 1, wherein an inner surface of the hollow inner layer and the inner surface of the lampshade body are each disposed with a light guiding structure.

9. The air-bag-form lampshade according to claim 8, wherein the light guiding structure consists of a plurality of light guiding particles formed on the respective inner surface to thereby form a matte surface.

10. The air-bag-form lampshade according to claim 8, wherein each of the light guiding structures consists of a plurality of light guiding patterns on the respective inner surface.
